(19) United States
(12) Patent Application Publication
(10) Pub. No.: US 2026/0159111 A1
(43) Pub. Date: Jun. 11, 2026

(54) COLLISION WARNING DEVICE, VEHICLE COMPRISING A COLLISION WARNING DEVICE, METHOD FOR OPERATING A COLLISION WARNING DEVICE, COMPUTER PROGRAM AND COMPUTER-READABLE MEDIUM

(71) Applicant: Continental Automotive Technologies GmbH, Hannover (DE)

(72) Inventors: Peter Schuster, Wiesbaden (DE); Sebastian Wehler, Hünstetten (DE)

(73) Assignee: Continental Automotive Technologies GmbH, Hannover (DE)

(21) Appl. No.: 19/179,251

(22) Filed: Apr. 15, 2025

(30) Foreign Application Priority Data
Apr. 15, 2024 (DE) 10 2024 203 425.8

(51) Int. Cl. B60W 50/14; B60W 30/095; B60W 50/00

(52) U.S. Cl. CPC B60W 50/14; B60W 30/0956; B60W 50/0097; B60W 2300/14; B60W 2420/403; B60W 2420/408; B60W 2420/54; B60W 2520/105; B60W 2540/18; B60W 2554/40; B60W 2554/80

(57) ABSTRACT

A collision warning device is disclosed, including a control apparatus. If relevance criterion is met, the control apparatus ascertains respective collision values of the collision parameter, relating to a predicted collision event between the trailer and an object for the control values of the predefined control value range, to take the respective collision values of the collision parameter for the control value range as a basis for ascertaining an impact function in relation to the trailer for the object. The impact function assigns to the control values of the control value range an impact value relating to the predicted collision event between the trailer and the object, to ascertain the overall impact function of the vehicle-trailer combination from the respective impact function in relation to the vehicle of the object and the respective impact function in relation to the trailer of the object.

### CROSS REFERENCE TO RELATED APPLICATION

The present application is a bypass continuation application of DE 10 2024 203 425.8 filed on Apr. 15, 2024, in the German Intellectual Property Office, the disclosure of which is herein incorporated by reference in its entirety.

### FIELD OF INVENTION

The invention relates to a collision warning device, to a vehicle comprising a collision warning device and to a method for operating a collision warning device. The invention also relates to a computer program and to a computer-readable medium.

### BACKGROUND

To prevent collisions of a vehicle in road traffic, collision warning devices arranged in the vehicle have been developed. Collision warning devices are driver assistance systems which are configured to monitor at least one area of the vehicle surroundings of a vehicle or a vehicle-trailer combination. If an object for which a collision event with the vehicle is predicted is located in the vehicle surroundings, the collision warning device of the vehicle generally outputs a signal in order to notify a vehicle driver of a possible collision event. It is thus possible to give the driver the opportunity to adjust the control of the vehicle to prevent the collision or to at least reduce a degree of severity of the collision. The collision warning devices may include, for example, turn assist systems for detecting a cyclist in a blind spot of a vehicle-trailer combination. More highly developed collision warning devices are configured to actively engage in the vehicle guidance.

Regulation (EU) 2019/2144 of the European Parliament and of the Council, for example, discloses legal regulations relating to said devices.

With the more highly developed collision warning devices, it is usual for collisions between the vehicle and the object in the surroundings of the vehicle to be predicted by a continuous incremented prediction of the positions of the vehicle and the object, in conjunction with a check for geometric overlaps. To prevent the predicted collision, use is made of rule-based approaches which provide control values for control parameters of the vehicle in accordance with a collision prevention strategy. The known current approaches for ascertaining the control values are associated with a relatively high computation effort, and the sets of rules used for collision prevention strategies are possibly not comprehensive or optimal.

An exemplary method and a system for collision prevention according to the prior art are disclosed in US 2008/0065328 A1. The method comprises the reception of input data relating to a set of objects outside the first vehicle, wherein an object position and an object speed are associated with each object by way of a sensor system arranged in a host vehicle. In another step, future trajectories of each external object are estimated, while an influence by the future trajectories of the other external objects is taken into account.

### SUMMARY

It is an object to reduce computation effort for providing a collision prevention strategy.

The object is addressed by the subject of the independent patent claims. Advantageous further developments of the present disclosure are described by the dependent patent claims, the description that follows and the figures.

A first aspect of the present disclosure relates to a collision warning device, wherein the collision warning device includes a control apparatus. The collision warning device may be provided, for example, for arrangement in a vehicle or an infrastructure element in order to predict a collision event. For example, a collision between the vehicle and an object may be defined as the collision event. The object may be, for example, a road user, such as another vehicle, a cyclist or a pedestrian. The object may also be a stationary object, such as a traffic sign, a traffic light or road barrier.

The collision warning device includes a control apparatus which may include, for example, a microprocessor or a microcontroller.

The control apparatus is configured to receive vehicle movement data which describe a movement of the vehicle of a vehicle-trailer combination. The vehicle movement data may describe, for example, a speed, a position and/or a spatial alignment of the vehicle.

The control apparatus is configured to receive object movement data for at least one object in the surroundings of the vehicle-trailer combination, which object movement data describe a movement of the at least one object. The object movement data may likewise describe a speed, a position and/or a spatial alignment of the object.

Provision is made for the control apparatus to be configured to take the vehicle movement data as a basis for ascertaining a movement equation for describing the movement of the vehicle as a function of time and a current control value of a control parameter of the vehicle. The current control value of the control parameter of the vehicle may be provided, for example, by a control apparatus of the vehicle. The movement equation may make it possible to predict a trajectory of the movement of the vehicle in a future time window. The time window may be 10 seconds, for example.

In other words, the control apparatus is configured to ascertain the movement equation from the vehicle movement data and the current control value of the control parameter of the vehicle. The movement equation makes it possible to predict a vehicle movement of the vehicle as a function of time. The movement equation is ascertained assuming that the current control value the control parameter of the vehicle remains the same. The control parameter may include, for example, a current acceleration of the vehicle and/or a current steering angle of the vehicle. The movement equation may make it possible to ascertain the trajectory of the vehicle over the specific time period.

The control apparatus is configured to take the object movement data of the at least one object and the vehicle movement data of the vehicle as a basis for ascertaining a movement equation for describing the movement of the respective at least one object in relation to the vehicle as a function of time and the current control value of the control parameter of the vehicle. In other words, the control apparatus is configured to ascertain the movement equation for describing the movement of the object. The control apparatus is configured to ascertain the movement equation for describing the movement of the respective at least one object in relation to the vehicle as a function of time and the current control value of the control parameter of the vehicle from the movement equation for describing the movement of the object in a global reference system and the movement equation for describing the movement of the vehicle in the global reference system. In other words, the control apparatus is configured to ascertain the movement equation which describes the movement of the respective at least one object in relation to the vehicle assuming that the current control value of the control parameter of the vehicle remains the same. The movement equation for describing the movement of the respective at least one object in relation to the vehicle makes it possible to ascertain a trajectory of the at least one object in relation to a reference system which is referred to the vehicle.

The control apparatus is configured to take the movement equation for describing the movement of the respective at least one object in relation to vehicle for the current control value of the control parameter as a basis for checking if the respective at least one object has met a predetermined relevance criterion. In other words, the control apparatus is configured to check whether the at least one object is relevant for further evaluation to ascertain a possible collision event between the object and the vehicle. The relevance of the object depends on whether the predetermined relevance criterion is met. The predetermined relevance criterion relates to the movement equation for describing the movement of the respective at least one object in relation to the vehicle. Provision may be made, for example, for the relevance criterion to be met when the movement equation of the object in relation to the vehicle results in a predefined minimum distance between the vehicle and the object being undershot. In other words, the relevance criterion may specify that the predefined minimum distance between the vehicle and the object is undershot by the addicted trajectory of the object relation to the vehicle.

Checking the object for relevance results in the advantage that the other method steps can be restricted to those objects for which in principle a possibility of a collision with the vehicle can be assumed. This can reduce the computation effort since further evaluation of the movement of an object which does not meet the relevance criterion can be omitted. The control apparatus is configured, if the relevance criterion is met, to take the movement equation in relation to the vehicle for control values of a predefined control value range as a basis for ascertaining respective collision values of a collision parameter relating to a predicted collision event between the vehicle and the respective at least one object. In other words, provision is made, in the event that the object is relevant, for collision values of a collision parameter which characterize a predicted collision event between the vehicle and the respective at least one object to be ascertained. The collision parameter may include, for example, a predicted energy which is produced in the event of a collision between the vehicle and the object. The collision value of the collision parameter is ascertained for the respective control values of the predefined control value range. The control values of the predefined control value range includes the current control value of the control parameter. The control apparatus is therefore configured to ascertain the collision value of the collision parameter which characterizes the predicted collisions between the vehicle and the object which arise when the current control value remains the same. In addition to the current control value of the control parameter, the control value range also includes other control values of the control parameter. In addition to the current control value, the other control values may include, for example, other control values around the current control value. If the control parameter is, for example, a steering angle of a steering system of the vehicle, the control value range may include, for example, a complete angular range of the steering angle which can be set by the steering system. The control value range may also be restricted to those control values which can be set within a predefined period of time starting from the current control values. The control values of the control value range may be at predefined distances from one another.

The control apparatus is configured to take the respective collision values of the collision parameter ascertained for the respective control values of the control value range as a basis for ascertaining an impact function in relation to the vehicle for the respective at least one object. The impact function assigns to the respective control values of the control value range a respective impact value which describes a degree of severity of the predicted collision event between the vehicle and the respective at least one object. In other words, the control apparatus is configured to take the respective collision values as a basis for ascertaining the impact function which can describe an intensity of the predicted collision event.

The control apparatus is configured to ascertain an overall impact function of the vehicle-trailer combination from the respective impact function in relation to the vehicle for the at least one object. In other words, the situation whereby several of the objects in the surroundings of the vehicle are detected may arise. The respective impact function which refers to the vehicle and the respective object can be ascertained for each of the detected objects. In order to be able to ascertain the optimum control value taking into account all relevant objects, the control apparatus is configured to combine the individual impact functions so as to form the overall impact function of the vehicle-trailer combination.

The control apparatus is configured to ascertain an optimum control value of the control parameter from the overall impact function of the vehicle-trailer combination according to an optimization method. In other words, the overall impact function of the vehicle-trailer combination maps the overall impact value in relation to the vehicle-trailer combination for all objects. The overall impact value may describe, for example, an intensity of the respective collisions. The control apparatus is configured to ascertain the optimum control value of the control parameter at which the overall impact value has a minimum.

The present disclosure results in the advantage that efficient ascertainment of optimum control values of the control parameter is made possible.

The present disclosure includes embodiments that result in additional advantages.

One development of the present disclosure makes provision for the control apparatus to be configured to receive trailer movement data which describe the movement of a trailer of the vehicle-trailer combination and/or to ascertain same from the vehicle movement data. In other words, according to one alternative, provision is made for the control apparatus to be configured to receive the trailer movement data. According to another alternative, provision is made for the control apparatus to be configured to evaluate the vehicle movement data in order to ascertain the trailer movement data. Provision may be made, for example, for geometric relations between the vehicle and the trailer to be stored in the control apparatus. The control apparatus may be configured to ascertain the trailer movement from a history of the movement of the vehicle taking into account the geometric relations.

The control apparatus is configured to take the trailer movement data as a basis for ascertaining a movement equation for describing the movement of the trailer as a function of time and the current control value of the control parameter of the vehicle. In other words, in addition to the movement equation for describing the movement of the vehicle, the movement equation for describing the movement of the trailer can also be ascertained. The equation is likewise based on the current control values of the control parameter of the vehicle.

The control apparatus is configured to take the object movement data of the at least one object and the trailer movement data as a basis for ascertaining a movement equation for describing the movement of the respective at least one object in relation to the trailer as a function of time assuming the current control value.

In the event of the object meeting the relevance criterion, the control apparatus is used to ascertain respective collision values of a collision parameter relating to a predicted collision event between the trailer and the respective at least one object, for the control values of the predefined control value range. In other words, in addition to the collision values of the collision parameter relating to a predicted collision event between the vehicle and the respective at least one object, the collision values of the collision parameter relating to the predicted collision event between the trailer and the respective at least one object also depends on the control value of the control parameter. The control apparatus is configured to take the respective collision values of the collision parameter for the control value range as a basis for ascertaining an impact function in relation to the trailer for the respective at least one object, which impact function assigns to the control values of the control value range an impact value relating to the collision event between the trailer and the respective at least one object.

The control apparatus is configured to ascertain the overall impact function of the vehicle-trailer combination from the respective impact function in relation to the vehicle of the at least one object and the respective impact function in relation to the trailer of the at least one object. In other words, the overall impact function of the vehicle-trailer combination results from the respective impact functions in relation to the vehicle and the trailer. The development results in the advantage that, in addition to possible collision events of the vehicle, possible collision events of the trailer can also be taken into account. As a result, in particular, collision events during turning or maneuvers of a vehicle-trailer combination can be predicted more reliably.

One development of the present disclosure makes provision for the predetermined relevance criterion to include a predefined minimum distance being undershot by a predicted minimum distance between the vehicle and the object. In other words, the control apparatus is configured to take the movement equation for describing the movement of the respective at least one object in relation to the vehicle for the current control value of the control parameter as a basis for ascertaining a predicted minimum distance between the vehicle and the object, which predicted minimum distance results from a predicted trajectory of the object in relation to vehicle. The control apparatus is configured to compare the predicted minimum distance with the predefined minimum distance. The predetermined relevance criterion specifies that the respective object is evaluated as relevant when the minimum distance between the vehicle and the object is undershot by the minimum distance. The development results in the advantage that a relevance criterion which is easy to check is provided to relevance of an object for a prediction of a collision event.

One development of the present disclosure makes provision for the collision parameter to include a duration until the collision event. In other words, the control apparatus is configured to ascertain the duration until the collision event between the vehicle-trailer combination and the object occurs.

One development of the present disclosure makes provision for the collision parameter to include a collision location of the collision event in relation to the vehicle-trailer combination. In other words, the control apparatus is configured to ascertain the collision location at which the predicted collision event takes place between the vehicle-trailer combination and the object. The collision location is defined in relation to the vehicle-trailer combination. The collision location may be defined, for example, in relation to the vehicle and/or the trailer. The collision location may describe, for example, a position of the collisions in relation to the vehicle and/or an alignment between the object and the vehicle upon collision. For example, the collision location may describe the location of the vehicle at which a collision with the object takes place and the angle at which the object collides with the vehicle at the location. The development results in the advantage that a collision parameter which is particularly suitable for ascertaining degree of severity of the collision event is ascertained.

One development of the present disclosure makes provision for the collision parameter to include a collision energy of the collision event. In other words, the control apparatus is configured to ascertain the collision energy which is released upon the predicted collision event. For example, provision may be made for a mass of the vehicle and a mass of the object to be known or ascertained by the control apparatus. The control apparatus can ascertain the energy released upon the collision event based on the speeds of the vehicle and the object upon the collision event which are ascertained by the control apparatus. The development has the advantage that, by way of the collision energy, there is a collision parameter available which is particularly suitable for estimating the extent of a collision event.

According to one development of the present disclosure, the control apparatus is configured to actuate the vehicle to set the optimum control value of the control parameter. In other words, the control apparatus is configured to set the respective control value of the at least one control parameter by actuating a transverse and/or longitudinal guidance system of the vehicle. For example, provision may be made for the control apparatus to actuate a steering angle, an acceleration response and/or a braking response of the vehicle to set the optimum control value. The development has the advantage that active engagement of the collision warning device in the vehicle guidance can prevent or mitigate a predicted collision event.

One development of the present disclosure makes provision for the collision parameter to include a steering angle and/or an acceleration. In other words, the control apparatus is configured to determine the impact function as a function of the steering angle and/or the acceleration of the vehicle. This has the advantage that the most important control parameters of the vehicle can be monitored.

According to one development of the present disclosure, the collision warning device is configured to actuate an output apparatus for outputting output signal to a driver of the vehicle to set the optimum control value of the control parameter. In other words, the collision warning device is configured, by means of an output apparatus, to instruct the driver of the vehicle to set the optimum control value the control parameter. The development results in the advantage that the collision warning device is designed to instruct the driver to prevent the collision event or to mitigate the collision event. The advantage that the collision warning device may be retrofitted more easily in known vehicles also results.

One development of the present disclosure makes provision for the collision warning device to include a sensor apparatus which is configured to detect the at least one object in the surroundings of the vehicle-trailer combination and to transmit the object movement data to the control apparatus, in other words that the collision warning device is configured to detect the at least one object in the surroundings of the vehicle-trailer combination by means of the sensor apparatus. For example, provision may be made for the sensor apparatus to include radar, ultrasonic or camera sensors which are configured to monitor the surroundings of the vehicle-trailer combination. The sensor apparatus may detect the at least one object and the surroundings and may track the movement of the object. Object movement data which are provided to the control apparatus can be generated from the detected movement of the object by the sensor apparatus.

One development of the present disclosure makes provision for the control apparatus to be configured to model the vehicle-trailer combination and/or the at least one object as a polygon in order to predict the collision event or at least one of the collision parameters. In other words, provision is made for a two-dimensional area or a three-dimensional volume of the vehicle-trailer combination and/or the object to be ascertained. A polygon representing the vehicle-trailer combination may be stored in the control apparatus. For example, one polygon for the vehicle and one polygon for the trailer may be provided. The polygon of the vehicle-trailer combination can be ascertained from the two polygons from an angle of the trailer. A polygon for describing the object can be generated, for example, from data from the sensor apparatus. For example, provision may be made for the sensor apparatus to detect a pulse sequence of the object. A corresponding polygon of the object can be generated by the control apparatus based on the scatter diagram. As an alternative, the control apparatus may be provided with a dataset of a polygon. Specific objects can be identified by the control apparatus and the corresponding polygons can be retrieved. The development has the advantage that the use of a polygon model instead of a scatter diagram for illustrating the vehicle-trailer combination can be used to provide a more accurate determination of a collision event and the collision parameters.

A second aspect of the present disclosure relates to a vehicle which has at least one collision warning device of the first aspect of the present disclosure. The collision warning device may be fixedly integrated in the vehicle or provided in the vehicle as a retrofit solution.

A third aspect of the present disclosure relates to a method for operating a collision warning device.

The method includes the following steps carried out by a control apparatus of the collision warning device.

One step includes receiving vehicle movement data which describe a movement of a vehicle of a vehicle-trailer combination.

One step includes receiving of object movement data for at least one object in the surroundings of the vehicle-trailer combination, which object movement data describe a movement of the at least one object.

One step includes taking the vehicle movement data as a basis for ascertaining a movement equation for describing the movement of the vehicle as a function of time and a current control value of a control parameter of the vehicle.

One step includes taking the object movement data of the at least one object and the vehicle movement data as a basis for ascertaining a movement equation for describing the movement of the respective at least one object in relation to the vehicle as a function of time and the current control value of the control parameter of the vehicle.

One step includes taking the movement equation for describing the movement of the respective at least one object in relation to vehicle for the current control value of the control parameter as a basis for checking if the respective at least one object has meta predetermined relevance criterion.

A step carried out if the relevance criterion is met includes taking the movement equation for control values of a predefined control value range as a basis for ascertaining respective collision values of a collision parameter, relating to a predicted collision event between the vehicle and the respective at least one object.

One step includes taking the respective collision values of the collision parameter for the control value range as a basis for ascertaining an impact function in relation to the vehicle for the respective at least one object, which impact function assigns to the control values of the control value range an impact value relating to the predicted collision event between the vehicle and the respective at least one object.

One step includes ascertaining an overall impact function of the vehicle-trailer combination from the respective impact function in relation to the vehicle for the at least one object.

One step includes ascertaining an optimum control value of the control parameter from the overall impact function of the vehicle-trailer combination according to an optimization method.

A fourth aspect of the present disclosure relates to a computer program including commands which cause the aforementioned collision warning device to execute or carry out the method steps, as have been described above by way of example, to ascertain the first digital output signal.

A fifth aspect of the present disclosure relates to a computer-readable medium on which the aforementioned computer program is stored. The computer-readable medium may be implemented as a data memory.

For carrying out the described steps, it is possible to provide, by way of the control device, a processor circuit having programming or software including program instructions which causes the processor circuit to perform an embodiment of the method when executing the program instructions. The processor circuit may have at least one microprocessor and/or microcontroller for this purpose. The program instructions may be stored in a data memory of the processor circuit.

The present disclosure also includes developments of the vehicle according to the present disclosure, of the method according to the present disclosure, of the computer program according to the present disclosure and of the computer-readable medium according to the present disclosure, which have features that have already been described in connection with the developments of the collision warning device according to the present disclosure. For this reason, the corresponding developments of the vehicle according to the present disclosure, of the method according to the present disclosure, of the computer program according to the present disclosure and of the computer-readable medium according to the present disclosure are not described again here.

For use cases or application situations that may arise for the method and are not explicitly described here, there may be provision for the method to involve an error message and/or a request for input of user feedback being output and/or a default setting and/or a predetermined initial state being set.

The present disclosure also includes the combinations of the features of the embodiments described.

### BRIEF DESCRIPTION OF THE DRAWINGS

One example embodiment of the present disclosure is described below. In the figures:

FIG. 1 shows a schematic illustration of a vehicle having a collision warning device and two objects;

FIG. 2 shows a schematic illustration of the vehicle having a collision warning device and one object;

FIG. 3 shows a schematic illustration of an ascertained minimum distance between the object and the vehicle;

FIG. 4 shows a schematic illustration of a collision location of a collision event in relation to the vehicle;

FIG. 5 shows another schematic illustration of a collision location of a collision event in relation to the vehicle;

FIG. 6 shows a schematic illustration of a collision location of a collision event in relation to a trailer;

FIG. 7 shows a schematic illustration of two impact functions;

FIG. 8 shows a schematic illustration of a resulting overall impact function;

FIG. 9 shows a schematic illustration of a sequence of a method for operating a collision warning device; and

FIG. 10 shows a schematic illustration of a sequence of a method for operating a collision warning device.

### DETAILED DESCRIPTION

The example embodiment explained below is an example embodiment of the present disclosure. In the example embodiment, the described components of the embodiment each constitute individual features of the present disclosure that should be considered independently of one another, that each also develop the present disclosure independently of one another and that should thus also be considered to be part of the present disclosure individually or in a combination other than that shown. Furthermore, the embodiment described may also be supplemented by further features of the present disclosure that have already been described.

In the figures, functionally identical elements are each provided with the same reference signs.

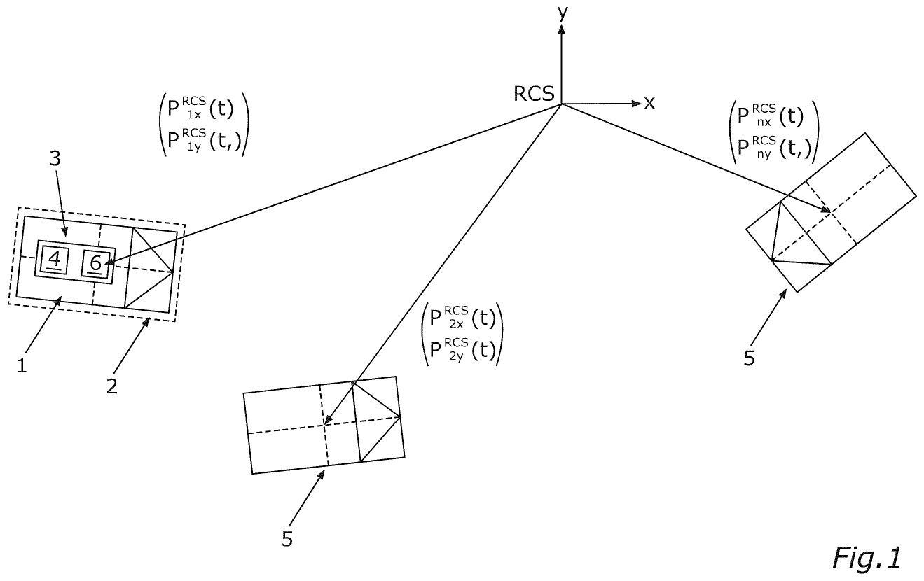

FIG. 1 shows a schematic illustration of a vehicle having a collision warning device and two objects.

The vehicle 1 shown in FIG. 1 may be part of a vehicle-trailer combination 2. The vehicle 1 may include a collision warning device 3 which may include a control apparatus 4. The collision warning device 3 may be provided to take vehicle movement data which describe a movement of the vehicle 1 and object movement data which describe the movement of an associated object 5 in the surroundings of the vehicle-trailer combination 2 as a basis for ascertaining a respective optimum value of a control parameter for controlling the vehicle 1. The optimum value of the control parameter may be provided to prevent a collision event between the vehicle 1 and the object 5 predicted by the control apparatus 4 or to reduce a degree of severity of the predicted collision event.

The vehicle movement data may be provided to the control apparatus 4 by the vehicle 1. The control apparatus 4 is configured to take the vehicle movement data as a basis for ascertaining a movement equation for describing the movement of the vehicle 1 as a function of time t and a current control value of a control parameter of the vehicle 1. The measurement equation may be provided to describe a trajectory 8 of the vehicle 1 in a fixed reference system RCS which is referred to the surroundings. The movement equation includes a time dependency, such that a position of the vehicle 1 can be ascertained as a function of time t. The movement equation is also dependent on the current control value of the control parameter of the vehicle. In other words, the movement equation is provided to describe the trajectory 8 of the vehicle 1 as a function of the set control value. The control parameter may include, for example, a current acceleration of the vehicle 1 and/or a current steering angle of the vehicle 1. It is thus possible to ascertain the trajectory 8 of the vehicle 1 which tracks the vehicle 1 for the respective control value of the control parameter. It is thus advantageously possible to ascertain the movement of the vehicle 1 when the current control value of the control parameter remains the same when the current control value of the control parameter changes.

The collision warning device 3 may include a sensor apparatus 6 which is configured to detect the object 5 and/or other objects 5 in the surroundings of the vehicle-trailer combination 2. The sensor apparatus 6 may include, for example, radar units, lidar units, ultrasonic units or camera units to detect the objects 5. The sensor apparatus 6 may be configured to detect the objects 5 multiple times at different points in time in order to ascertain the object movements of the respective objects 5. The object movements data be provided to the control apparatus 4 by the sensor apparatus 6 for further evaluation. As with the vehicle 1, the control apparatus 4 may be used to ascertain a movement equation of the object 5, which equation may also be referred to the fixed coordinate system RCS in order to describe the trajectory 8 of the object 5 in the fixed reference system.

FIG. 1 shows a traffic scene in the surroundings of the vehicle 1 which may include multiple objects 5. The movements of the objects 5 may be described by movement equations in relation to the street coordinate system RCS.

The trajectories 8 of the objects 5 and the vehicle 1 may be described in the road coordinate system RCS as parametric kinematic equations, movement equations for short. An information source for the movements may include the sensor apparatus 6 in the vehicle 1, an infrastructure apparatus outside the vehicle, or a Car2X device.

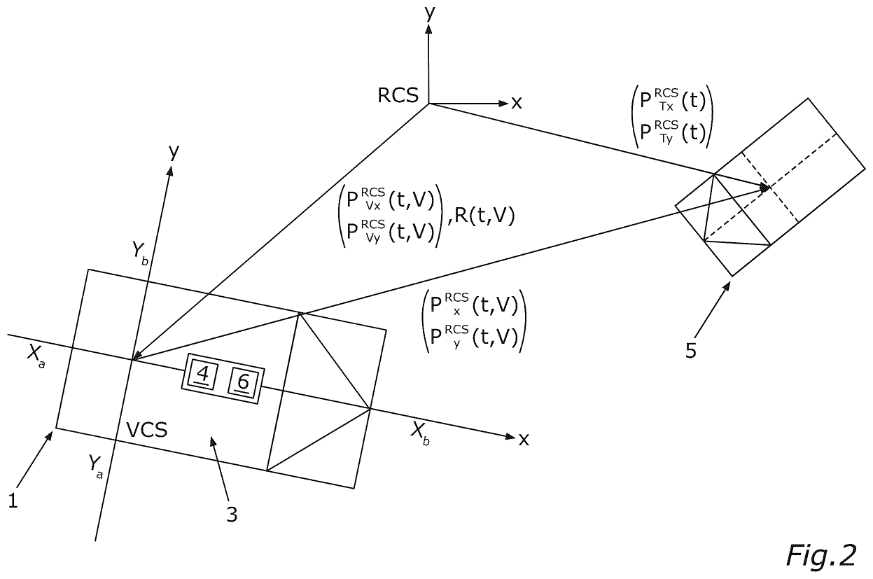

FIG. 2 shows a schematic illustration of the vehicle having a collision warning device and one object.

The control apparatus 4 is configured to take the object movement data of the respective object 5 and the vehicle movement data as a basis for ascertaining a movement equation for describing the movement of the respective object 5 in relation to the vehicle 1 as a function of time t and the current control value of the control parameter of the vehicle 1.

Provision may be made, for example, for the control apparatus 4 to take the object movement data of the respective object 5 as a basis for ascertaining a movement equation describing the movement of the respective object 5 in relation to the fixed road coordinate system RCS as a function of time t. The movement equation for describing the movement of the respective object 5 in relation to the fixed road coordinate system RCS as a function of time t may be described, for example, as a polynomial description of the second order as follows:

$$( \begin{matrix}{P}_{Tx}^{RCS} ( t ) \\ {P}_{Ty}^{RCS} ( t )\end{matrix} ) = ( \begin{matrix}x + v \cdot cos ( φ ) \cdot t - \frac{{v}^{2} \cdot \frac{δ}{L} \cdot sin ( φ ) - a \cdot cos ( φ )}{2} \cdot {t}^{2} \\ y + v \cdot sin ( φ ) \cdot t + \frac{{v}^{2} \cdot \frac{δ}{L} \cdot cos ( φ ) + a \cdot sin ( φ )}{2} \cdot {t}^{2}\end{matrix} )$$

In this case, x,y may be the position, v may be the speed, a may be the acceleration, φ may be the orientation, δ may be the steering angle and L may be the wheelbase.

The movement equation of the vehicle 1 may be described as a function of the control parameters.

$$( \begin{matrix}{P}_{Vx}^{RCS} ( t , V ) \\ {P}_{Vy}^{RCS} ( t , V )\end{matrix} )$$

The control parameters may include the acceleration a and the steering angle δ.

$$V = ( a , δ )$$

In another step, the respective movement equations which are coupled to the coordinate system RCS can be calculated in order to ascertain the movement of the respective objects 5 by way of a movement equation for describing the movement of the respective object 5 in relation to the vehicle 1 as a function of time t and the current control value of the control parameter of the vehicle 1.

Taking into account a rotational position of the vehicle R(t,V), the following may result for the equation of the object 5 in relation to the vehicle 1:

$$( \begin{matrix}{P}_{x} ( t , V ) \\ {P}_{y} ( t , V )\end{matrix} ) = R ( t , V ) \cdot ( \begin{matrix}{P}_{T x}^{R C S} ( t ) - {P}_{V x}^{R C S} ( t , V ) \\ {P}_{Ty}^{R C S} ( t ) - {P}_{Vy}^{R C S} ( t , V )\end{matrix} )$$

This makes it possible to describe the trajectory 8 of the respective object 5 in a coordinate system VCS which is referred to the vehicle 1.

The movement of the objects 5 is illustrated relative to the vehicle coordinate system VCS as a function of time t and the movement of the vehicle 1.

The movement equation of the object is transformed into a concomitantly carried ego vehicle coordinate system (VCS) which takes into account the rotation of the ego vehicle R(t,V).

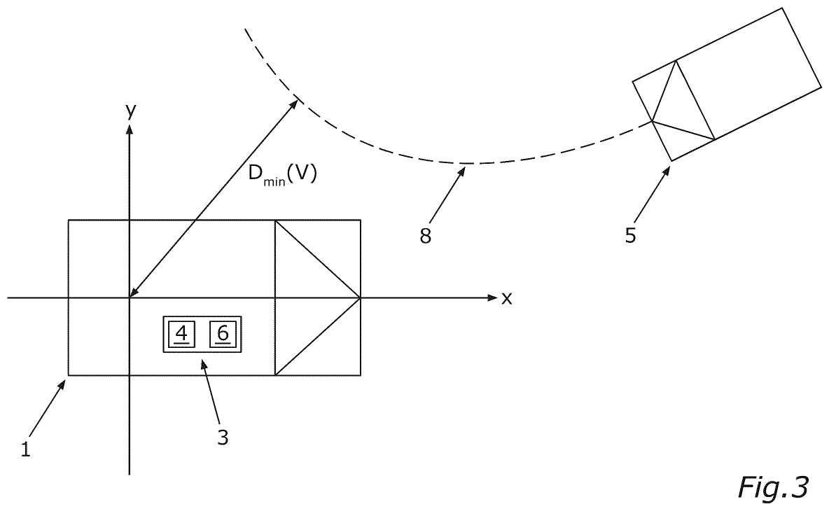

FIG. 3 shows a schematic illustration of an ascertained minimum distance between the object and the vehicle.

The control apparatus 4 may be configured to take the movement equation for describing the movement of the respective at least one object 5 in relation to vehicle 1 for the current control value of the control parameter as a basis for checking if the respective at least one object 5 has met a predetermined relevance criterion.

The relevance criterion may be referred, for example, to a minimum distance Dₘᵢₙ(V) which results when the trajectory 8 is tracked by the object 5 between the object 5 and the vehicle 1. This makes it possible to estimate whether it is necessary to continue to take into account the object 5 for collision prevention.

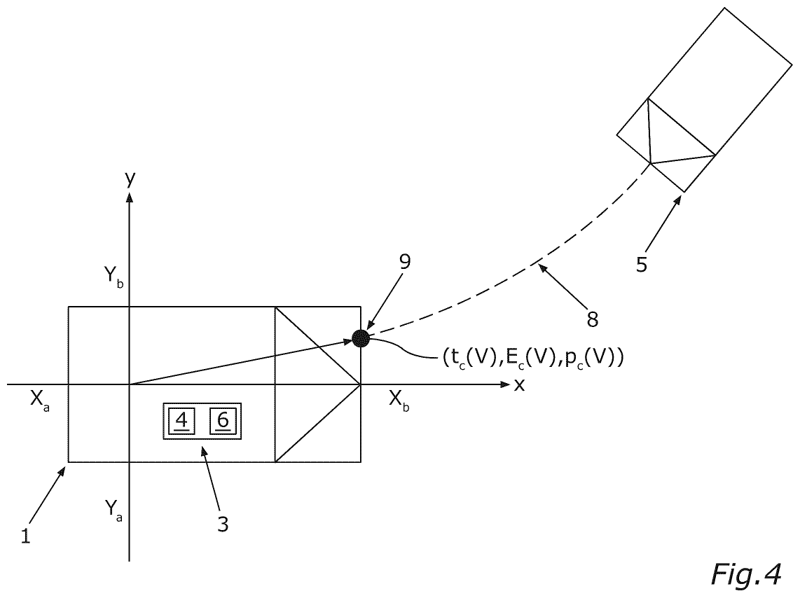

FIG. 4 shows a schematic illustration of a collision location of a collision event in relation to the vehicle.

The control apparatus 4 is configured, if the relevance criterion is met, to take the movement equation for control values of a predefined control value range as a basis for ascertaining respective collision values of a collision parameter. In other words, if the relevance check reveals that the object 5 is relevant, respective collision values of the collision parameter are ascertained as a function of control values of the predefined control value range. The collision parameters may include, for example, a collision energy of the collision event, a collision location 9 or a time until the collision event. The respective collision values may be ascertained for the current control value of the control parameter as well as for other control values which are within the control value range. The control value range may describe, for example, a maximum possible range of the values of the control parameter or a range of the values of the control parameter which can be set within a predefined time window. The respective collision values may be ascertained by applying a variation method in which the current control values may be varied. This makes it possible to more easily ascertain the respective collision values. It is thus advantageously possible to ascertain the specific control values at which the predicted collision event occurs and the control values at which the collision event does not occur. To this end, the collision values of the collision parameters may be ascertained as a function of the respective control values.

FIG. 4 shows the vehicle which may be described as a polygon with the dimensions ((Xₐ, Yₐ), (X_{b}, Y_{b})) and the object 5 which tracks the trajectory 8.

The time until collision with the front side of the vehicle 1 and the rear side of the vehicle 1 results from:

$$( {X}_{n} ∈ \{ {X}_{a} , {X}_{b} \} ) {t}_{c , x} ( V ) = min \{ t ∈ {ℝ}^{+} \vert {P}_{x} ( t , V ) - {X}_{n} = 0 ∧ {P}_{y} ( t , V ) ∈ [ {Y}_{a} , {Y}_{b} ] \}$$

The time until collision with a right or left side of the vehicle 1 results from:

$$( {Y}_{n} ∈ \{ {Y}_{a} , {Y}_{b} \} ) {t}_{c , y} ( V ) = min \{ t ∈ {ℝ}^{+} \vert {P}_{y} ( t , V ) - {Y}_{n} = 0 ∧ {P}_{x} ( t , V ) ∈ [ {X}_{a} , {X}_{b} ] \}$$

The resulting time until collision results from:

$${t}_{c} ( V ) = min \{ {t}_{c , x} ( V ) , {t}_{c , y} ( V ) \}$$

Variations in the control values ΔV=(Δa, Δδ) can be utilized to be able to efficiently ascertain variations in the time until the collision.

An approximation of the change in the time until the collision with the vehicle 1 on the front side or the rear side may result as follows:

$${t}_{c , x}^{*} ( V + Δ V ) = {t}_{c , x} - \frac{1}{{\dot{P}}_{x} ( {t}_{c} , V )} \cdot ( \frac{\partial {P}_{x} ( {t}_{c} , V )}{\partial a} \cdot Δ a + \frac{\partial {P}_{x} ( {t}_{c} , V )}{\partial δ} \cdot Δδ )$$

An approximation of the change in the time until the collision with the vehicle 1 on the right or left side may result as follows:

$${t}_{c , y}^{*} ( V + Δ V ) = {t}_{c , y} - \frac{1}{{\dot{P}}_{y} ( {t}_{c} , V )} \cdot ( \frac{\partial {P}_{y} ( {t}_{c} , V )}{\partial a} \cdot Δ a + \frac{\partial {P}_{y} ( {t}_{c} , V )}{\partial δ} \cdot Δδ )$$

An overall result of the variation may thus result as follows:

$${t}_{c}^{*} ( V + Δ V ) = min \{ t ∈ \{ {t}_{c , x}^{*} , {t}_{c , y}^{*} \} \vert {P}_{x} ( t , {V}^{*} ) ∈ [ {X}_{a} , {X}_{b} ] ∧ {P}_{y} ( t , {V}^{*} ) ∈ [ {Y}_{a} , {Y}_{b} ] \}$$

The collision location 9 on the vehicle 1 may be derived from the resulting time until contact:

$${p}_{c} ( V ) = ( {P}_{x} ( {t}_{c} , V ) , {P}_{y} ( {t}_{c} , V ) )$$

The impact energy Ec(V) is proportional to the derivation of the trajectory c, which is a constant

$${E}_{c} ( V ) = \{ \begin{matrix}c \cdot {{\dot{P}}_{x} ( {t}_{c} , V )}^{2} & if {t}_{c} exists and {t}_{c} = {t}_{c , x} \\ c \cdot {{\dot{P}}_{y} ( {t}_{c} , V )}^{2} & if {t}_{c} exists and {t}_{c} = {t}_{c , y} \\ 0 & else\end{matrix}$$

The impact function Iₙₘ(V) in relation to the vehicle n and the object m may be a function which may be dependent on the time until contact, the collision location 9 and the collision energy.

$${I}_{n m} ( V ) = f ( {t}_{c} ( V ) , {p}_{c} ( V ) , E ( V ) )$$

Example of features of this function

$$I ( V ) = 0 for V : {t}_{c} ( V ) > {t}_{t h r e s h}$$

I(V) weighted by the collision position on the ego vehicle
I(V) proportional to E(V)

The resulting impact function Iₙ(V) is the sum of the individual impact functions Iₙₘ(V):

$${I}_{n} ( V ) = {\sum }_{m \neq n} {I}_{n m} ( V )$$

The optimum values of the control parameters for collision reduction derive from the collision map which may be formed by the resulting impact function Iₙ(V):

$${V}_{o p t} = arg min \{ I ( V ) \}$$

Calculation of the impact function for all objects 5 in the scene and derivation of optimum control measures

$${V}_{m , o p t} = arg min \{ {I}_{m} ( {V}_{m} ) \} , m \neq n$$

Calculation of the impact function for the vehicle 1 using the probable control actions of the targets:

$${I}_{n} ( V ) = {\sum }_{m \neq n} {I}_{n m} ( V , {V}_{m , opt} )$$

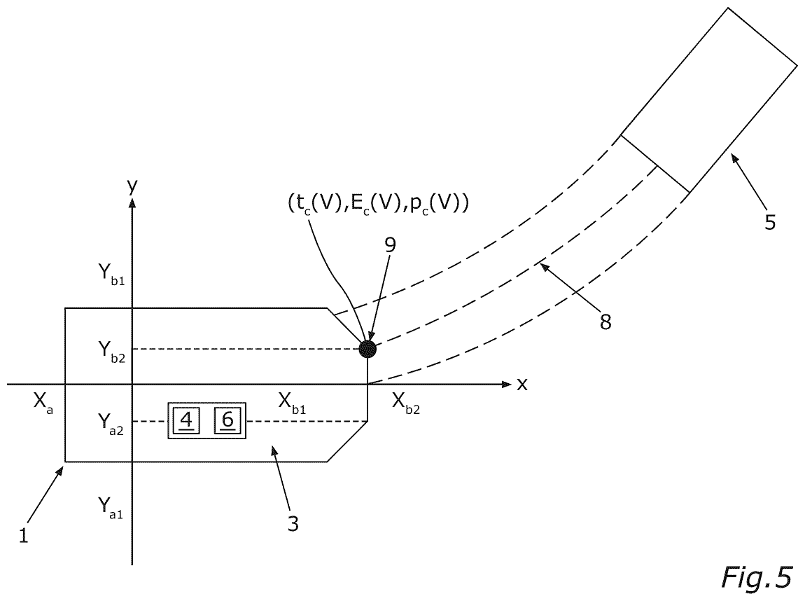

FIG. 5 shows another schematic illustration of a collision location 9 of a collision event in relation to the vehicle 1.

The collision location 9 which may result from the trajectory 8 of the object 5 the ascertained using a polygonal model of the vehicle 1 and the object 5.

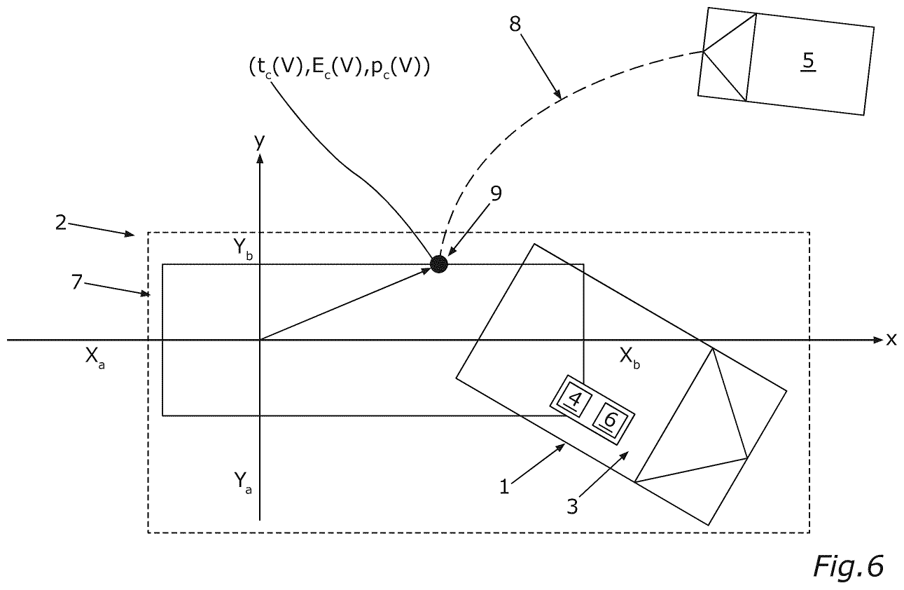

FIG. 6 shows a schematic illustration of a collision location of a collision event in relation to a trailer.

The figure shows the object 5 which tracks the trajectory 8, and the collision location 9. The collision warning device 3 may also be configured to take into account a trailer 7 of the vehicle-trailer combination 2. In this case, collision events between the trailer 7 and the object 5 may be ascertained analogously to the evaluation of the collision event between the vehicle 1 and the object 5. To this end, trailer movement data which describe the movement of the trailer 7 of the vehicle-trailer combination 2 may be received by control apparatus 4. As an alternative, the trailer movement data may be ascertained from the vehicle movement data by the control apparatus 4. The trailer movement data may also be ascertained by the sensor apparatus 6 of the collision warning device 3. In order to be able to take into account both the predicted collision event of the vehicle 1 and the predicted collision event of the trailer 7, it is possible to combine the respective impact functions of the vehicle 1 and the trailer 7.

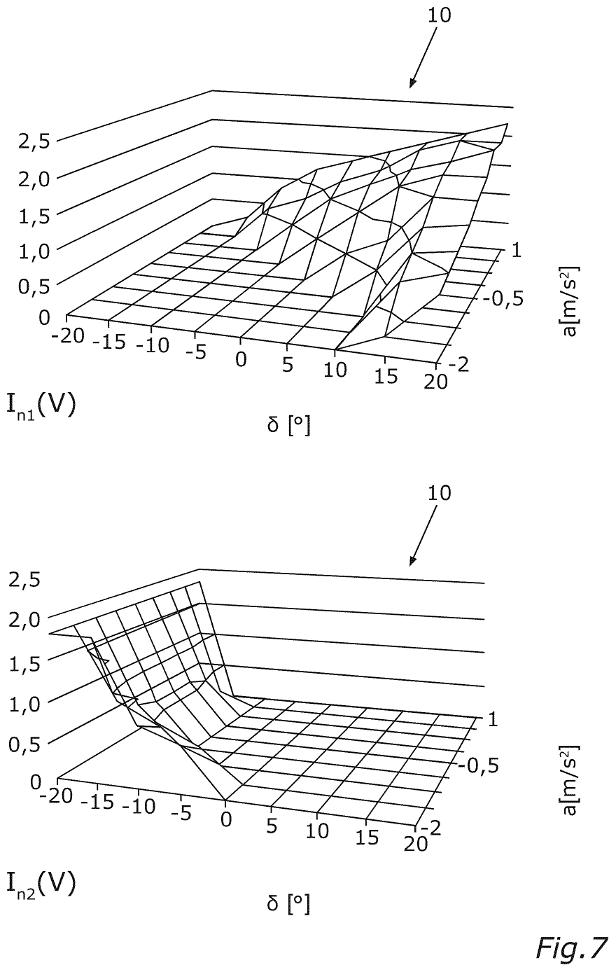

FIG. 7 shows a schematic illustration of two impact functions.

The control apparatus 4 is designed to take the respective collision values of the collision parameter for the control value range as a basis for ascertaining an impact function in relation to the vehicle 1 for the respective object 5. The impact function assigns to the control values of the value range a respective impact value which describes the predicted collision event between the vehicle 1 and the respective object 5. The impact value may describe an evaluation of a severity of the predicted collision event. The impact value may be calculated from the respective collision values. For example, provision may be made for the impact value to be dependent on the impact energy and the impact position of the collision event.

The impact function may be determined for each of the objects 5. In this case, the impact function refers only to the respective object 5. In order to make it possible to ascertain the optimum values for a traffic situation, it may be necessary to take into account all of the objects 5. To this end, the respective impact functions may be combined to form an overall impact function. The overall impact function may be ascertained, for example, by adding the respective impact functions. The control apparatus is configured to ascertain the optimal control value of the control parameter from the overall impact function of the vehicle-trailer combination according to the optimization method.

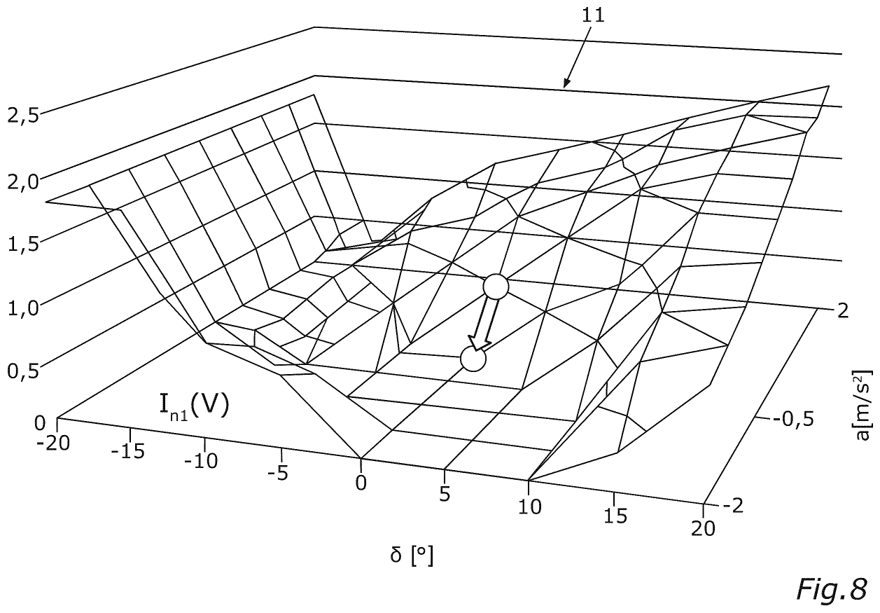

FIG. 8 shows a schematic illustration of a resulting overall impact function.

To prevent or mitigate a collision event, the collision warning device 3 may be configured to engage in a vehicle guidance system in order to set the optimum control value of the control parameter. In addition or as an alternative, provision may be made for output signals to be output from the collision warning device 3 to a driver of the vehicle 1 by means of an output apparatus in order to instruct the driver to set the optimum value.

The impact function may be calculated from the collision values. The nearest minimum of the impact function represents the optimum values of the control parameters of the vehicle 1 for minimizing the collision.

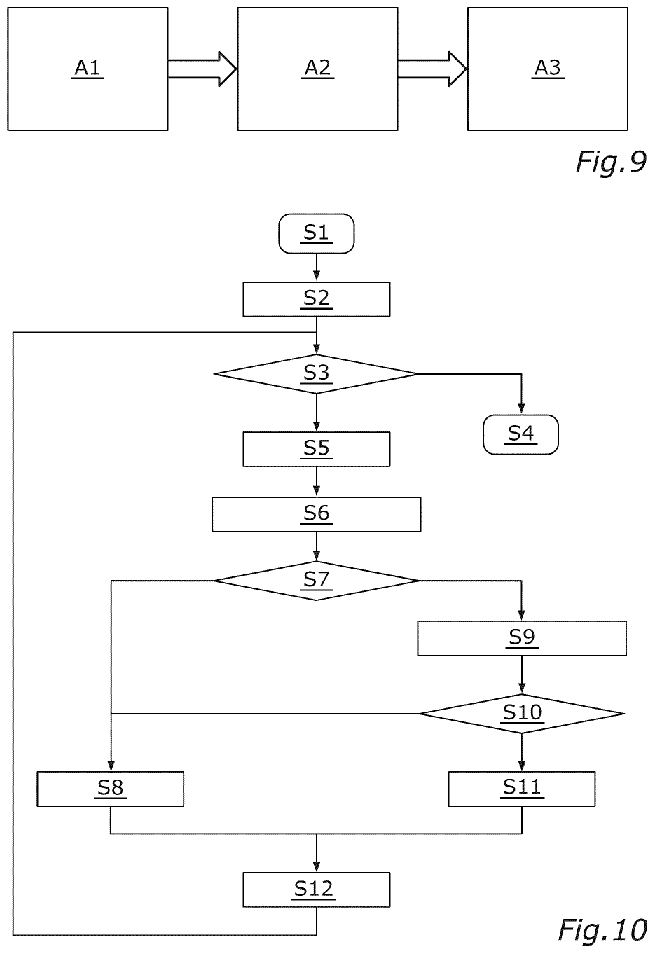

FIG. 9 shows a schematic illustration of a sequence of a method for operating a collision warning device.

The schematic illustration of a sequence shows three main sections of the method.

The first main section A1 includes the control apparatus 4 receiving vehicle movement data for describing the movement of the vehicle 1, trailer movement data for describing the movement of the trailer 7, and receiving object movement data for describing the movement of the object 5. The movement equations relating to the vehicle 1 are ascertained based on the movement data.

The second main section A2 of the method includes checking a relevance of the respective objects 5 and ascertaining collision values of the respective collision parameters which describe a predicted collision event.

The third main section A3 of the method describes ascertaining the respective impact functions between the object 5 and the vehicle land between the objects 5 and the trailer 7. The main section also includes ascertaining the overall impact function which results from the individual impact functions.

The third main section A3 of the method may also include measures for preventing the collision event or for minimizing the collision event.

FIG. 10 shows a schematic illustration of a sequence of a method for operating a collision warning device.

At the beginning of the method, provision may be made in a step S1 for specification of an overall impact function which assigns an impact value 0 to all of the control values of the control value range.

Provision may be made in a step S2 for a control apparatus to ascertain movement equation relating to the global coordinate system from object movement data from objects 5 in the surroundings of the vehicle-trailer combination 2.

Provision may be made in a step S3 for the control apparatus 4 to check whether a pair made of a vehicle 1 and an object 5 or of a trailer 7 and an object 5 have already been evaluated.

If there is not a pair which has not yet been evaluated, the control apparatus 4 may end the method in a step S4.

If the control apparatus determines that the respective pair has not yet been evaluated, the movement equation of the respective object 5 relative to the vehicle 1 and/or relative to the trailer 7 may be ascertained (S5).

In a step S6, it is possible to take the movement equation of the object 5 relative to the vehicle as a basis for ascertaining a time at which the object 5 is at a minimum distance from the vehicle 1.

In a step S7, it is possible to check whether the minimum distance between the object 5 and the vehicle 1 undershoots a predefined minimum distance.

If this is not the case, in a step S8, the impact value may be set to 0 since it is possible to assume that no collision event has occurred.

In the event that the minimum distance is undershot, a collision time until the collision event between the vehicle 1 and an object 5 occurs is determined in a step S9.

The presence of a collision time can be checked in a step S10.

In the event that a collision time may be ascertained and thus a collision event is predicted, the impact function relative to the vehicle 1 for the respective object 5 may be ascertained for a control value range in a step S11.

In the event that an impulse time cannot be ascertained and thus a collision event is not predicted, the impact function may be set to 0 in a step S8.

After step S8 or step S11, the overall impact function may be updated in a step S12. In this case, the overall impact function present may be supplemented by the object-related impact function.

In a subsequent step S12, the control apparatus 4 may be used to check whether an object 5 which has not yet been taken into account is located in the vehicle surroundings. If this is the case, the preceding steps may be repeated for the relevant object 5.

The method steps may be repeated at specific time intervals.

The method describes a strategy for collision prevention and impact minimization which is based on data which are provided by the sensor apparatus 6 or other inputs such as V2X communication which collect object data such as current position and movement. The approach differs from known methods by the prediction of an impact as a function of collision properties. The collision properties used may include the time until the collision, the collision position on the vehicle 1 and the collision energy in the event of a collision between the vehicle 1 and the observed objects 5. One advantage of the described strategy is that the minimization of the impact function already enables direct prevention and mitigating control measures.

In contrast to known algorithms, the described method does not involve any complex route planning and evaluation calculation but examines the actual scene for possible impending collisions and directly derives control measures to prevent or mitigate a predicted collision of the vehicle 1. The actual scene is examined in the coordinate system VCS of the vehicle 1 and small possible modifications of the lateral and/or longitudinal control actions of the vehicle 1 are applied. The computation power actually required is drastically reduced due to the type of these definitions. This reduction in the required computation power affords the possibility of executing the actual algorithm on the collision warning device 3 itself.

The present disclosure provides an algorithm for rapid collision calculation which results in an impact function in the value range of the control parameters which may be used immediately for collision prevention or minimization.

The present disclosure provides an algorithm for rapid collision calculation which may be used directly for the control value range for collision prevention or minimization. The control value range may include control values of control parameters for influencing the movement of the vehicle 1 such as an acceleration and a steering angle or equivalent features.

As a requirement, it may be assumed that the fundamental kinematic properties are known for all of the relevant objects 5 in the traffic scene. For the ego vehicle 1, these properties may be provided by sensors on board such as speed or inertia sensors. Additional sensors such as lidar, radar, ultrasonic, cameras or other sources may be used to monitor the movements of the object 5.

The aim is to ascertain a respective so-called impact function from the kinematic properties of the respective object 5. The impact function assigns an impact value to each control value of the control value range. The impact value describes the predicted degree of severity of the impact as a function of the impact energy, the impact angle, the impact location and/or the estimated mass of the object 5, for example.

The algorithm for calculating a respective impact function of an object pair (n,m) including the vehicle and the object consists of the following steps:

Representing the use of parametric kinematic equations to represent the movement of all relevant objects 5 in the scene in a global coordinate system RCS. The kinematic properties T are formed by the position (Px, Py) and orientation R as a function of the control parameters V.

Determination of the relevance of the object 5 by checking whether the minimum distance Dₘᵢₙ(V) between the object 5 and the vehicle 1 is below a predefined threshold value.

If an object 5 is classified as relevant, the collision parameters of time until the collision, collision energy and/or the collision on the vehicle 1 are ascertained for each individual object 5 by solving the kinematic equations. In addition, the mass of the objects 5 may be ascertained by the control apparatus 4 based on sensor information from the sensor apparatus 6, for example by way of a radar cross section of the object 5 ascertained by means of radar.

The impact function Iₙₘ(V) is subsequently generated from the collision parameters by varying the control values in the control value range. The solution of the kinematic equations is only costly for the first point in the control value range at (0,0), the solution of which may be used for other variations. If the above algorithm is applied iteratively for each object pair, the overall impact function in the control value range Iₙ(V) may be ascertained.

The resulting overall impact function in the control value range may be used to identify, prevent or mitigate a collision. The optimum value of the control parameters of the vehicle 1 is given, for example, by the point of the minimum value of the overall impact function 11 which is closest to the current control values.

The proposed algorithm is fast and directly results in a control output for collision prevention or minimization.

The algorithm may be applied to multiple objects 5 simultaneously and provides an optimum overall result in relation to the collision prevention and minimization taking into account all of the object 5. The main applications are rapid calculations before a crash, collision prevention and minimization. The approach may also be useful as a driver assistance system, in autonomous driving and in route planning.

Furthermore, the concept may be generalized for multiple ego vehicles and be used in C2C or V2I locations such as junction monitoring, for example. The impact function may also be useful for visualization purposes or human-machine interfaces.

The initial impact function is be calculated at ΔV=O for each pair of objects in the scene. This calculation represents the greatest computation effort caused by solving equations.

For N objects, the number of operations is O(N2). When the approach “variation of the inputs” is used, the calculation of the entire impact function (ΔV≠0) involves significantly less computation effort.

The solution of the equations (for example polynomial equations) is a standard numerical problem and highly efficient implementations are therefore readily available.

Overall, the example shows how an algorithm for collision prevention may be provided on the basis of an impact function in the value range of the control parameters.

### LIST OF REFERENCE SIGNS

1 Vehicle
2 Vehicle-trailer combination
3 Collision warning device
4 Control apparatus
5 Object
6 Sensor apparatus
7 Trailer
8 Trajectory
9 Collision location
10 Impact function
11 Overall impact function

1. A collision warning device, wherein the collision warning device comprises a control apparatus comprising at least one of a microprocessor or a microcontroller which is configured
to receive vehicle movement data which describe a movement of a vehicle of a vehicle-trailer combination, and
to receive object movement data for at least one object in a surroundings of the vehicle-trailer combination, which object movement data describe a movement of the at least one object,
to take the vehicle movement data as a basis for ascertaining a movement equation for describing the movement of the vehicle as a function of time and a current control value of a control parameter of the vehicle,
to take the object movement data of the at least one object and the vehicle movement data as a basis for ascertaining a movement equation for describing the movement of the respective at least one object in relation to the vehicle as a function of time and the current control value of the control parameter of the vehicle,
to take the movement equation for describing the movement of the respective at least one object in relation to vehicle for the current control value of the control parameter as a basis for checking if the respective at least one object has met a predetermined relevance criterion,
if relevance criterion is met, to take the movement equation for control values of a predefined control value range as a basis for ascertaining respective collision values of a collision parameter, relating to a predicted collision event between the vehicle and the respective at least one object,
to take the respective collision values of the collision parameter for the control value range as a basis for ascertaining an impact function in relation to the vehicle for the respective at least one object, which impact function assigns to the control values of the control value range an impact value relating to the predicted collision event between the vehicle and the respective at least one object,
to ascertain an overall impact function of the vehicle-trailer combination from the respective impact functions in relation to the vehicle for the at least one object, and
to ascertain an optimum control value of the control parameter from the overall impact function of the vehicle-trailer combination according to an optimization method.

2. The collision warning device as claimed in claim 1, wherein the control apparatus is further configured
to at least one of receive trailer movement data which describe a movement of a trailer of the vehicle-trailer combination or ascertain the trailer movement data from the vehicle movement data,
to take the trailer movement data as a basis for ascertaining a movement equation for describing the movement of the trailer as a function of time and the current control value of the control parameter of the vehicle,
to take the object movement data of the at least one object and the trailer movement data as a basis for ascertaining a movement equation for describing the movement of the respective at least one object in relation to the trailer as a function of time and the current control value of the control parameter of the vehicle,
if the relevance criterion is met, to ascertain respective collision values of a collision parameter, relating to a predicted collision event between the trailer and the respective at least one object, for the control values of the predefined control value range,
to take the respective collision values of the collision parameter for the control value range as a basis for ascertaining an impact function in relation to the trailer for the respective at least one object, which impact function assigns to the control values of the control value range an impact value relating to the predicted collision event between the trailer and the respective at least one object, and
to ascertain the overall impact function of the vehicle-trailer combination from the respective impact function in relation to the vehicle of the at least one object and the respective impact function in relation to the trailer of the at least one object.

3. The collision warning device as claimed in claim 1, wherein the predetermined relevance criterion includes a predefined minimum distance being undershot by a predicted minimum distance between the vehicle and the at least one object.

4. The collision warning device as claimed in claim 1, wherein the collision parameter includes a duration until the predicted collision event.

5. The collision warning device as claimed in claim 1, wherein the collision parameter includes a collision location of the predicted collision event in relation to the vehicle-trailer combination.

6. The collision warning device as claimed in claim 1, wherein the collision parameter includes a collision energy of the predicted collision event.

7. The collision warning device as claimed in claim 1, wherein the control apparatus is configured to actuate the vehicle to set the optimum control value of the control parameter.

8. The collision warning device as claimed in claim 1, wherein the control parameter includes at least one of a steering angle or an acceleration.

9. The collision warning device as claimed in claim 1, wherein the control apparatus is configured to actuate an output device for outputting output signals to instruct a driver of the vehicle to set the optimum control value of the control parameter.

10. The collision warning device as claimed in claim 1, wherein the collision warning device comprises a sensor apparatus which is configured to detect the at least one object in the surroundings of the vehicle-trailer combination and to transmit the object movement data to the control apparatus.

11. The collision warning device as claimed in claim 1, wherein the collision value of the collision parameter is ascertained by polygonal modeling of at least one of the object or the vehicle-trailer combination.

12. A vehicle comprising a collision warning device as claimed in claim 1.

13. A method for operating a collision warning device, the method carried out by a control apparatus of the collision warning device, the control apparatus comprising at least one of a microprocessor or a microcontroller, the method comprising:
receiving vehicle movement data which describe a movement of a vehicle of a vehicle-trailer combination,
receiving of object movement data for at least one object in surroundings of the vehicle-trailer combination, which object movement data describe a movement of the at least one object,
taking the vehicle movement data as a basis for ascertaining a movement equation for describing the movement of the vehicle as a function of time and a current control value of a control parameter of the vehicle,
taking the object movement data of the at least one object and the vehicle movement data as a basis for ascertaining a movement equation for describing the movement of the respective at least one object in relation to the vehicle as a function of time and the current control value of the control parameter of the vehicle,
taking the movement equation for describing the movement of the respective at least one object in relation to vehicle for the current control value of the control parameter as a basis for checking if the respective at least one object has met a predetermined relevance criterion,
if the relevance criterion is met, taking the movement equation for control values of a predefined control value range as a basis for ascertaining respective collision values of a collision parameter, relating to a predicted collision event between the vehicle and the respective at least one object,
taking the respective collision values of the collision parameter for the control value range as a basis for ascertaining an impact function in relation to the vehicle for the respective at least one object, which impact function assigns to the control values of the control value range an impact value relating to the predicted collision event between the vehicle and the respective at least one object,
ascertaining an overall impact function of the vehicle-trailer combination from the respective impact function in relation to the vehicle for the at least one object, and
ascertaining an optimum control value of the control parameter from the overall impact function of the vehicle-trailer combination according to an optimization method.

14. A computer program comprising commands which cause the collision warning device to carry out the method steps as claimed in claim 13.

15. A non-transitory computer-readable medium on which the computer program as claimed in claim 14 is stored.
